(19) United States
(12) Patent Application Publication
(10) Pub. No.: US 2008/0055227 A1
(43) Pub. Date: Mar. 6, 2008

(54) REDUCED COMPONENT DISPLAY DRIVER AND METHOD

(75) Inventor: Kongning Li, Toronto (CA)

Correspondence Address: VEDDER PRICE KAUFMAN & KAMMHOLZ, 222 N. LASALLE STREET, CHICAGO, IL, 60601, US

(73) Assignee: ATI Technologies Inc., Markham (CA)

(21) Appl. No.: 11/468,667

(22) Filed: Aug. 30, 2006

(51) Int. Cl. G09G 3/36

(52) U.S. Cl. 345/100

(57) ABSTRACT

A display driver circuit for driving display elements in a row of a display array, includes an m input, n-bit input multiplexer; a digital to analog converter, and a one input, m output, analog output multiplexer. A clock source, clocks the input and output multiplexers, to sequentially provide an analog output corresponding to one of said m n-bit inputs, at a corresponding one of said m outputs of said output multiplexer.

### FIELD OF THE INVENTION

The present invention relates generally to an LCD/LED source driver and more particularly to a driver for an LCD/LED or similar display array.

### BACKGROUND OF THE INVENTION

Conventional analog displays formed from cathode ray tubes (CRTs) are facing obsolescence. Instead, modern displays are being formed as two dimensional arrays of emissive elements, typically in the form of liquid crystals, light emitting diodes (LEDs), organic light emitting diodes (OLEDs), Surface-conduction Electron emitter Display (SEDs), plasma cells or the like.

Emissive elements are arranged in a two-dimensional array. Each element represents one pixel in the array, and may include one or more active components. For example color liquid crystal displays (LCDs) typically include three liquid crystal cells (or sub-pixels) per pixel, with each cell representing one color component of the pixel. The three cells, in combination with back lighting form the emissive element that can be used to display a pixel of arbitrary color.

Conveniently, these newer displays are significantly thinner and lighter than conventional CRT displays. As such they may be miniaturized and form part of a variety of electronic devices including televisions, computer monitors, digital media players, cell phones, personal digital assistants, MP3 players, and the like.

As each display is made of a multitude of individual display elements, suitable drive circuitry is required. As each display element is typically formed with three color emitting components, the drive circuitry typically includes three separate driver elements for each pixel. For high resolution displays a large number of components with D/A converters for each display element are required to drive the displays. This, in turn, requires drive circuitry that consumes a large amount of power and requires significant silicon area.

Accordingly, an improved display driver having fewer electronic components is desirable.

### SUMMARY OF THE INVENTION

Exemplary of an embodiment of the present invention, multiple (m) digital values received by a display driver are multiplexed, and converted to corresponding analog signals, using a single digital to analog converter. The resulting analog signals are demultiplexed prior to driving an interconnected display. In this way, the number of digital to analog converter forming part of the display driver may be reduced.

In accordance with an embodiment of the present invention, there is provided a display driver circuit for driving display elements in a row of a display array. The display driver circuit comprises: m inputs; an input selector, having m n-bit inputs and an n-bit output for providing a selected one of the m n-bit inputs, the m n-bit inputs interconnected with the m inputs; an n-bit digital to analog converter, receiving the n-bit output of the selector, and providing an analog output; and an output selector having an analog input interconnected with the analog output of the digital to analog converter, and m analog outputs providing the analog input at a selected one of the m analog outputs. A clock source, clocks the input and output selectors, to sequentially provide an analog output corresponding to one of the m n-bit inputs, at a corresponding one of the m analog outputs of the output selector.

In accordance with another aspect of the present invention, there is provided a method of driving an analog display array. The method comprises receiving m digital values, representing m pixels to be displayed on the display array; multiplexing the m digital values; sequentially converting the m digital values to corresponding analog signals, using a single digital to analog converter, to provide m sequential analog values; and demultiplexing the m sequential analog values to create m analog signals to drive m elements in a row of the analog display array.

In accordance with another embodiment of the present invention, there is provided an electronic device comprises a display array, having display elements arranged in rows and columns; a display driver circuit interconnected with the display array, the display driver circuit comprising: m inputs; an input selector, having m n-bit inputs and an n-bit output for providing a selected one of the m n-bit inputs, the m n-bit inputs interconnected with the m inputs; an n-bit digital to analog converter, receiving the n-bit output of the selector, and providing an analog output for driving the display elements; an output selector having an analog input interconnected with the analog output of the digital to analog converter, and m analog outputs providing the analog input at a selected one of the m outputs. A clock source clocks the input and output selectors, to sequentially provide an analog output corresponding to one of the m n-bit inputs, at a corresponding one of the m analog outputs of the output selector.

In accordance with yet another embodiment of the present invention there is provided a display driver circuit for driving display elements in a row of a display array. The display driver circuit comprising: an m input, n-bit input multiplexer; a digital to analog converter, receiving an n-bit output from the n-bit multiplexer; a one input, m output, analog output multiplexer. A clock source, to clock the input and output multiplexers, to sequentially provide an analog output corresponding to one of the m n-bit inputs, at a corresponding one of the m outputs of the output multiplexer.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 schematically illustrates a display, including LCD elements arranged in a two dimensional array;

FIG. 2 is a block diagram of a conventional LCD driver, for driving the display of FIG. 1;

FIG. 3 is a timing diagram, illustrating signals in the LCD driver of FIG. 2;

FIG. 4 is a block diagram of a driver, exemplary of an embodiment of the present invention;

FIG. 5 is a timing diagram, illustrating signals in the driver of FIG. 4;

FIG. 6 is a block diagram of a further driver, exemplary of another embodiment of the present invention; and

FIG. 7 is a timing diagram, illustrating signals in the LCD driver of FIG. 6; and

FIG. 8 is a block diagram of an example device including the display of FIG. 1, and the driver of FIG. 4 or FIG. 6.

### DETAILED DESCRIPTION

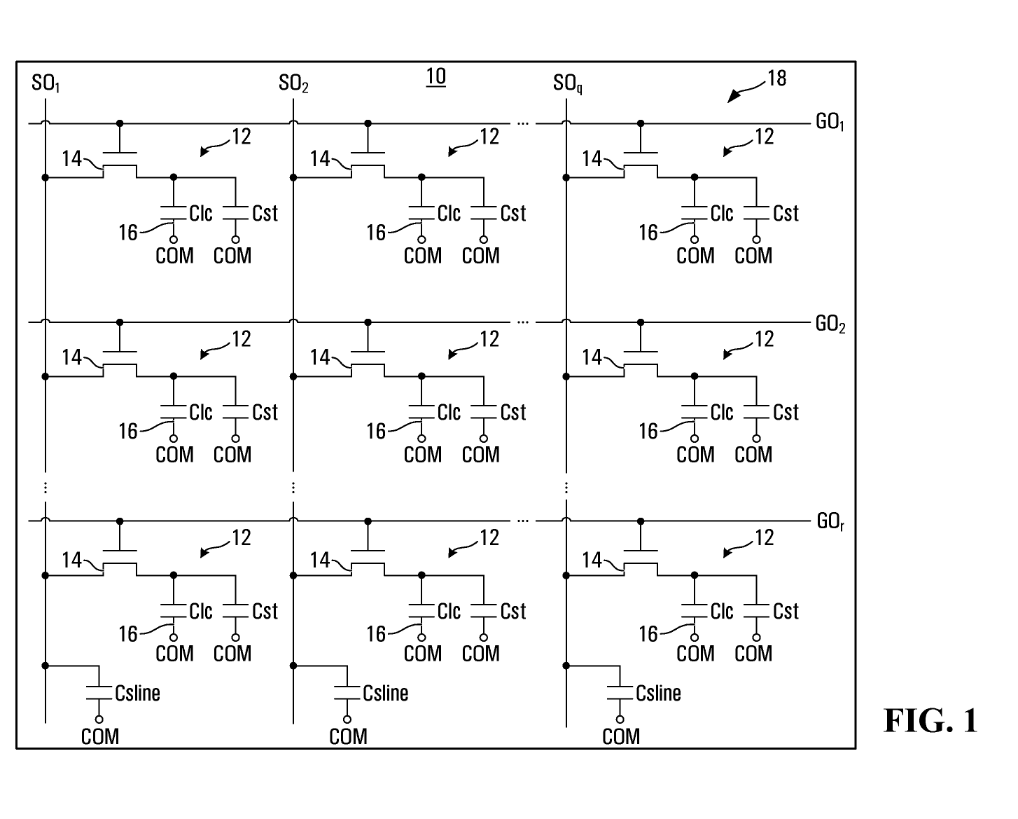

FIG. 1 is a partial schematic diagram of a conventional display 10 that may take the form of a TFT liquid crystal display panel. As illustrated, a plurality of emissive cells 12 including transistors 14, liquid crystals 16 are arranged in a two dimensional array 18. In the example embodiment, array 18 has size q×r. Example transistors 14 are thin film, field effect transistors (TFTs). Source lines (SO) of transistors 12 within a column of the array are interconnected. Similarly gate lines (GO) of the transistors 14 within a row are interconnected. Each transistor 14 is used as a gate line controlled switch for providing a signal to change the orientation of an interconnected liquid crystal 16, to vary the amount of light of particular color passed by the liquid crystal. More specifically, an analog voltage at a source line (SO) in a currently active row changes the state of the associated liquid crystal 16. A row is made active by asserting the corresponding gate line (GO) of TFT switch (i.e. turning the TFT ON). The liquid crystal 16 remains in its changed state for a finite duration while the TFT is OFF, as a result of its inherent capacitance C_{lc} and an additional storage capacitance Cₛₜ connected in parallel with liquid crystal 16. As noted, a display pixel is typically formed by three liquid crystals in close proximity, one of each to control the amount of red, green, and blue light, emitted by each cell.

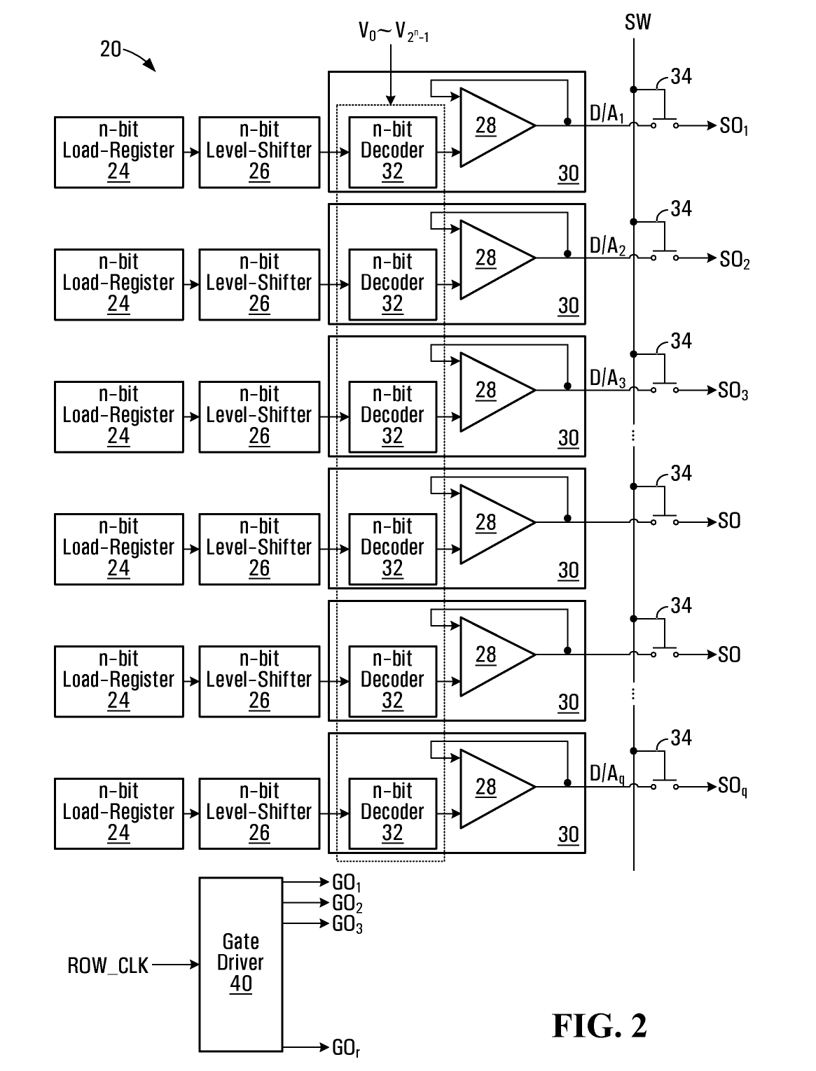

A driver circuit 20 as illustrated in FIG. 2 is used to drive all q source lines (SO) within a row of display 10, simultaneously. As illustrated driver circuit 20 includes q n-bit load registers 24 that each receives a data element representing a pixel in row of a two dimensional image, from a sampling register (not shown). Each n-bit load registers 24 provides an output to an n-bit level shifter 26 which, in turn, feeds an digital to analog converter 30, including n-bit decoder 32 and operational amplifier 28, acting as a buffer. The n-bit decoder 32 outputs an analog output signal, appropriate for an interconnected display 10, and in the range V₀˜V_{2″-1′} corresponding to the value of the n-bit data input of 0˜(2″-1). Operational amplifier 28 acts as a buffer (voltage follower), and provides an isolated analog signal used to drive an interconnected source line (SO) of array 18. A switch 34 associated with each output, controls when the analog output is provided to the source line.

A gate driver 40 is capable of asserting gate lines (GO) associated with each of the rows of array 18, and thus acts as active-row selector. Gate lines are asserted by applying a pre-determined voltage, thereby allowing current to flow from source to drain in the TFTs/FETs of an associated row. As such, gate driver 40 has r outputs, each providing a fixed output when active, to drive an interconnected gate line (GOⱼ) of array 18. Gate driver 40 is controlled by a clock input (ROW_CLK). On an edge of ROW_CLK, the output of the r outputs of gate driver 40, that is asserted advances.

In operation, gate driver 40, asserts gate lines GOⱼ in a single row (see FIG. 1). A corresponding row of an image to be represented on display 10 having q data elements is read from memory or data sampling registers (not shown) and provided to load registers 24. The n-bit level shifters 26 shift the level of digital outputs of load registers 24 to an input range acceptable level of the n-bit decoder 32 which in turn drives operational amplifier 28. Operational amplifier 28 provides analog outputs (D/A₁ to D/A_{q}) that drive the source line (SO₁ to SO_{q}) for all source lines in a particular row.

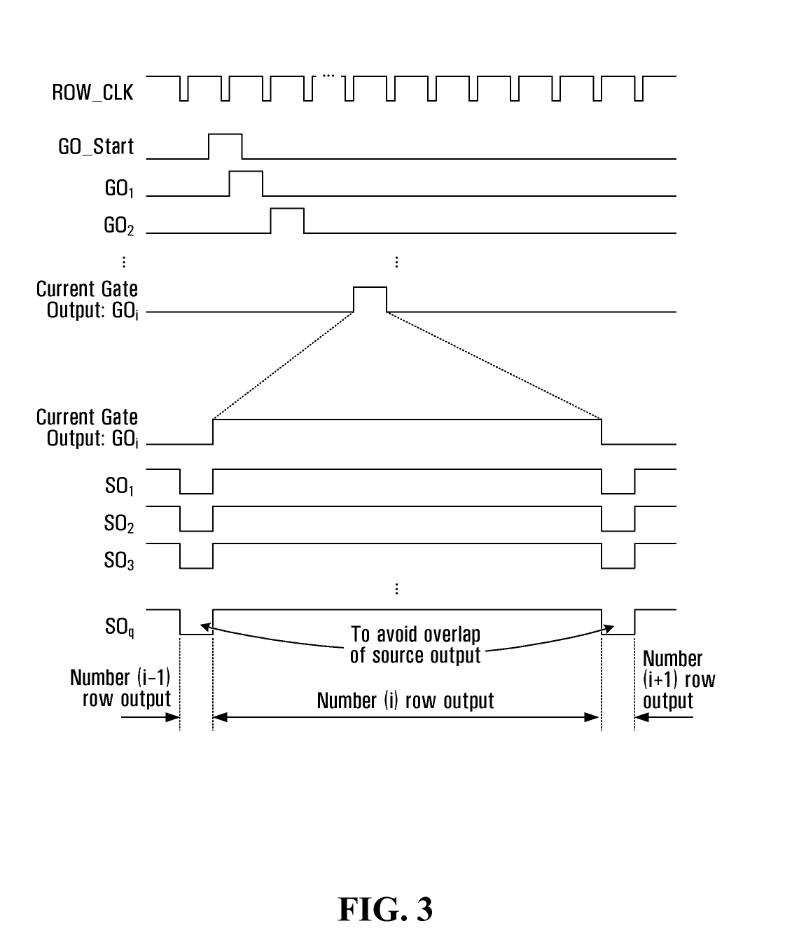

Timing of signals provided to gate lines GO (ROW_CLK) and switches 34 (SW), as well as outputs of source lines (SO) are illustrated in FIG. 3. Source line outputs (SO) are analog signals having varying amplitudes, but are illustrated as having equal amplitudes, to better illustrate timing. Switches 34 are activated by a signal SW, for a fraction of the time between clock signals (ROW_CLK) advancing gate driver 40. After a row of data has been provided to the source lines (SO₁ to SO_{q}) of a currently asserted column, q new sampled data values are provided to load registers 24 which in turn drive the next row of display elements, after the asserted gate line is advanced and switches 34 are again activated. This is repeated for all rows of the display.

As a result of capacitances C_{lc} and Cₛₜ associated with each liquid crystal 16, each display element 12 retains its state, while elements in the remaining r-1 rows of array 18 are refreshed by digital to analog converters 30 (i.e. about r cycles of ROW_CLK). As will now be appreciated, driver 20 includes an n-bit level shifter, n-bit decoder and operational amplifier for each display element in a row. For a q column (i.e. q×r) display, driver 20 thus includes q such level shifters, decoders and operational amplifiers.

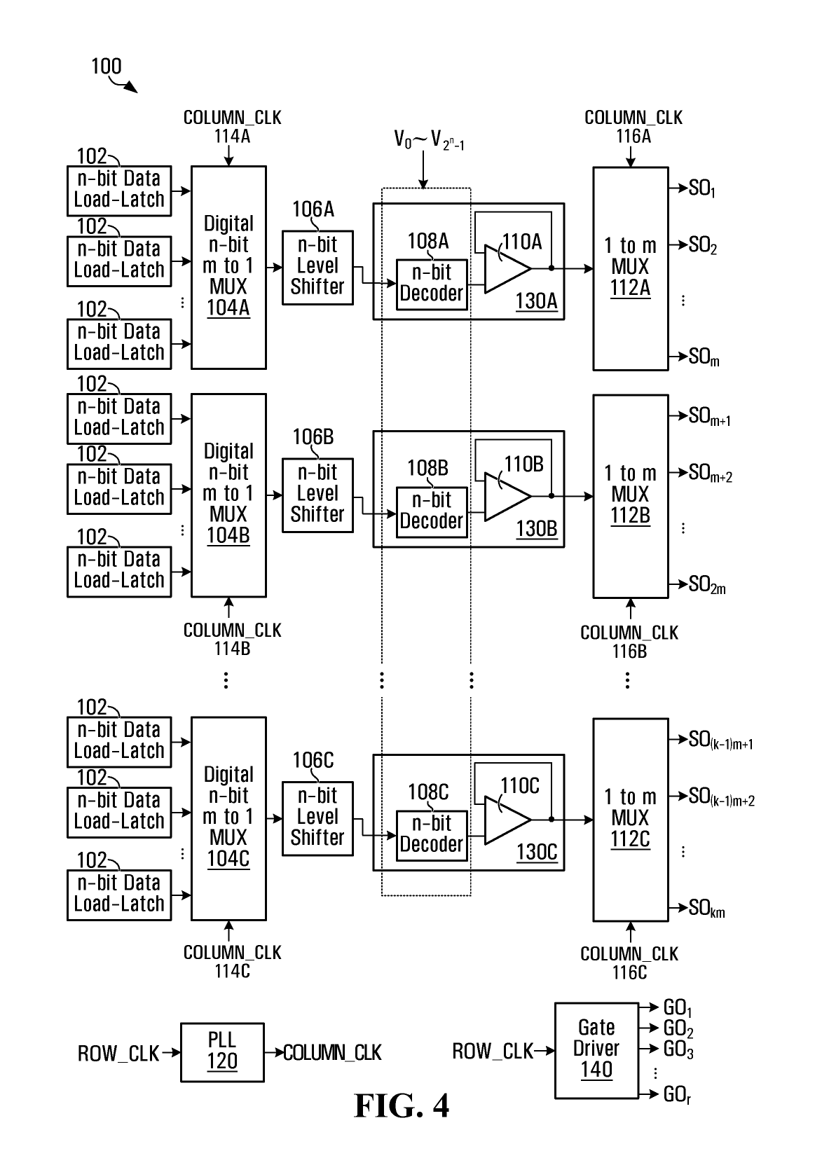

FIG. 4 accordingly illustrates an improved source driver 100 exemplary of an embodiment of the present invention. For reasons that will become apparent, source driver 100 is suitable for driving an array 18 having q×r=(k×m)×r array columns of pixels.

As illustrated, source driver 100 includes k×m n-bit load registers 102 (like the q n-bit load registers 24 of source driver 20). However the first m of the k×m load registers 102 feed an input selector 104a. Input selector 104a may be an m:1, n-bit digital selector, and includes m inputs and one output, and allows selection of one of its m inputs for presentation at its output. Input selector 104a may, for example, be formed as a digital multiplexer. Selector 104a takes a selected one of its m n-bit inputs to provide a single n-bit output to an associated n-bit level shifter 106a. Which input of selector 104a is provided to its output is selectable, for example, by a clock signal provided at clock input 114a.

The output of n-bit level shifter 106a is provided to an n-bit digital to analog converter 130a. Digital to analog converter 130a includes an n-bit decoder 108a, and a buffer in the form of operational amplifier 110a. Again, n-bit decoder 108a provides an analog voltage level value corresponding to the n-bit input of n-bit decoder 108a. The output of n-bit decoder 108a feeds operational amplifier 110a, acting as a buffer, to provide an analog output. An 1:m analog output selector 112a, that may take the form of an analog multiplexer has a single input, and m analog outputs. Selector 112a receives the analog output of operational amplifier 110a to provide an analog output signal at a selected one of its m possible outputs. Which one of the m outputs of output selector 112a is interconnected to its single input is provided is also selectable, for example, by a clock signal provided at clock input 116a. Conveniently, a single digital to analog converter 130a interconnects input selector 104a to output selector 112a.

The second m of the n-bit load registers 102b feeds a second m:1 input selector 104b, that may be formed in the same way as selector 104a. Each successive m of the k×m n-bit load registers further feeds another selector (not shown) like selector 104a, 104b and 104c.

A further identical input selector 104b, n-bit level shifter 106b, digital to analog converter 130b (including n-bit decoder 108b, and op-amp 110a) and analog output selector 112b, are arranged in the same manner as input selector 104a, n-bit level shifter 106a, digital to analog converter 130a and analog output selector 112a. Additional k-2 input selectors, k-2 n-bit level shifter, k-2 digital to analog converter (including n-bit decoder, and op-amp) and k-2 analog output selector, are also arranged in the same manner as selector 104a, n-bit level shifter 106a, digital to analog converter 130a and analog output selector 112a. For clarity only the k^{th} selector 104c, n-bit level shifter 106c digital to analog converter 130c (including n-bit decoder 108c and op-amp 130a) and analog output selector 112c are further illustrated. Individually and collectively input selectors 104a, 104b, 104c are referred to as input selectors 104; n-bit level shifters 106a, 106b, 106c as n-bit level shifters 106; digital to analog converters 130a, 130b, 130c as digital to analog converters 130; and output selectors 112a, 112b, 112c are referred to as input selectors 112.

Clocks to the k input selectors and output selectors (e.g. inputs 114a, 114b, 114c, 116a 116b, 116c) are interconnected to each other and to a clock source 120 to control the states (i.e. input to output interconnections) of the input selectors 104 and output selectors 112, respectively. On an edge of a clock signal of the clock inputs (e.g clock inputs 114a, 114b, 114c), which input of an input selector 104 is connected to its single output advances. Similarly, on an edge of a clock signal of clock inputs 116a, 116b, 116c which one of the m inputs of output selector 112 is provided to its single output, advances.

In the depicted embodiment, clock source 120 is derived from (i.e. phase locked loop) to the ROW_CLK signal. Of course, clock source 120 could otherwise be generated, for example using a frequency-divider synchronized to the data sampling clock used in sampling-registers upstream of load registers 102 (not shown).

A gate driver 140, like gate driver 40, is capable of row-wise asserting gate lines (GO) in each of the rows of array 18 of an interconnected display 10 (FIG. 1). Again, gate lines (GO) are asserted by applying a pre-determined voltage, thereby allowing current to flow from source to drain of transistors 14. As such, gate driver 140 has r outputs, each providing a fixed output when active, to drive an interconnected gate line (GOⱼ) of array 18. Gate driver 140 is controlled by a clock input (ROW_CLK). On an edge of ROW_CLK, the output of the r outputs of gate driver 40 that is asserted advances.

In operation k×m load registers 102 are loaded for each row of data, concurrently, with data representative of pixels in a row of an image. n-bit values may be loaded from a frame buffer or sampling registers (not shown). Once all k×m n-bit load registers have been loaded, the contents of a single one of the k×m load registers 102 is output at each input selector 104. These output values are provided to an interconnected n-bit level shifters 106, n-bit decoders 108, and operational amplifiers 110, to form k analog outputs at the output of operational amplifiers 110 (i.e. the outputs of digital to analog converters 130). These, in turn, are provided to the single input of an interconnected output selector 112 and presented at a single selected one of each of their m analog outputs.

Selectors 104,112 are advanced by a single clock signal (COLUMN_CLK) at respective clock inputs 114, and clock inputs 116, by a clock source 120. The states of selectors 104 and 112 are synchronized. In this way, the J^{th} input of a selector 104 is converted into a corresponding analog signal at the J^{th} output of a corresponding selector 112 (e.g. the J^{th} input of selector 104b is provided to the J^{th} output of selector 112b). Thus, selectors 112 sequentially present k outputs to an interconnected display 20, in each clock cycle of clock source 120. Conveniently, clock source 120 is clocked at least m times in a clock cycle of gate driver 140, at a rate that is at least m=q/k as great as the row rate. Clock source 120 may be synchronized with gate driver 140, to output m clock pulses following the falling edge of ROW_CLK.

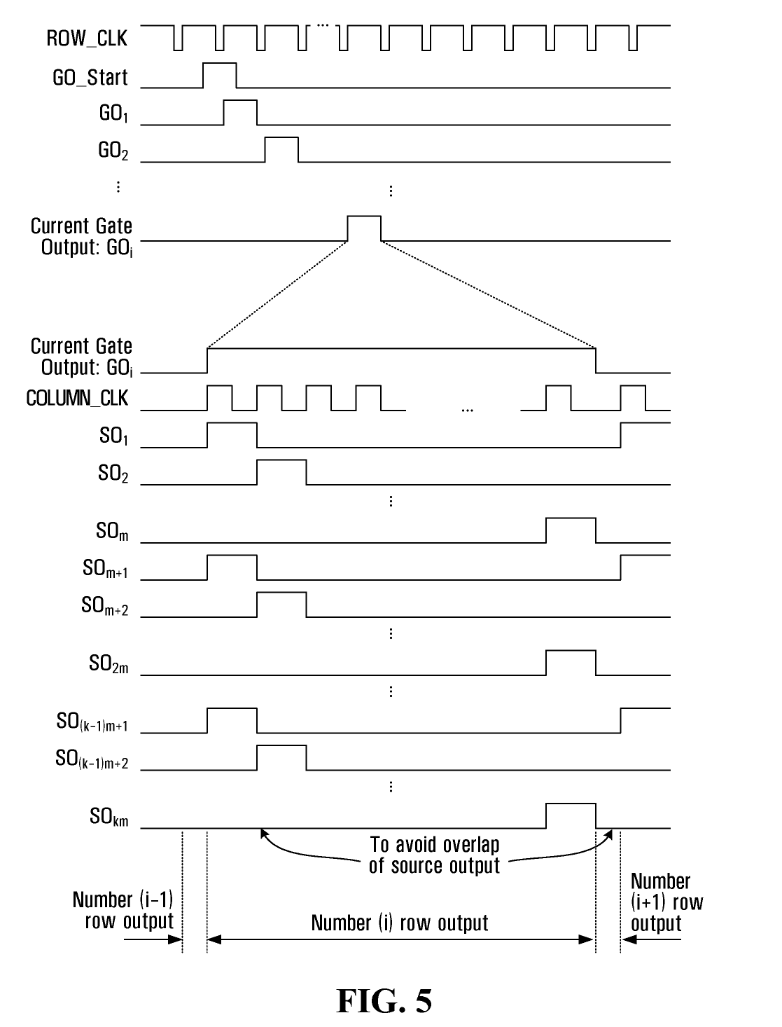

Example timing of clock signal (ROW_CLK) used to driver gate driver 140; the clock signal (COLUMN_CLK) output by clock source 120, the outputs D/A converters 130 provided to source lines SO (SO₁, SO₂ . . . SOₘ, SOₘ₊₁, SOₘ₊₂, SO₂ₘ . . . SOₖₘ) are illustrated in FIG. 5. Again the amplitudes of analog source line outputs (SO) are displayed as equal, only to illustrate output timing.

Each input selector 104 thus serves to time-division-multiplex m digital signals that are sequentially converted to analog signals by an interconnected digital to analog converter 130. This produces a time-division-multiplexed analog signal. The time-division-multiplexed analog signals are then demultiplexed by selectors 112, for presentation at source lines SO.

Conveniently each display element 12 includes sufficient inherent capacitance C_{lc} and additional storage capacitance Cₛₜ to charge and retain the applied voltage until the row (and thus element) is again refreshed. The display driver 100 may thus present an entire q×r pixel image, which q=k×m, in the same time period required by driver 20.

Advantageously, driver 100 includes only k n-bit level shifters 106, and k digital to analog converters 130—e.g. k operational amplifiers 110, and k n-bit decoders 108. Not surprisingly, driver 100 may be formed using fewer transistors and less integrated circuit space, than driver 20 (FIG. 2). As well, power consumption of driver 100 is reduced as a result of the reduced transistor count. Driver 100 thus lends itself to use in smaller electronic devices that may portable and not powered by a mains source.

Notably for driver 100, all outputs SO are not presented at identical times, but are instead delayed and time-division multiplexed/de-multiplexed by selectors 104, and 112, in accordance with clock source 120. So, the time a signal at line SOᵢ charges the capacitor Clc and Cst for a particular display element 12 is reduced from that in conventional driver 20. For most displays, and especially for smaller and medium size displays, such as mobile phones, digital media players, personal digital assistants, MP3 players, and the like, this reduction in time to charge is entirely acceptable, and Clc and Cst will hold sufficiently until re-freshed.

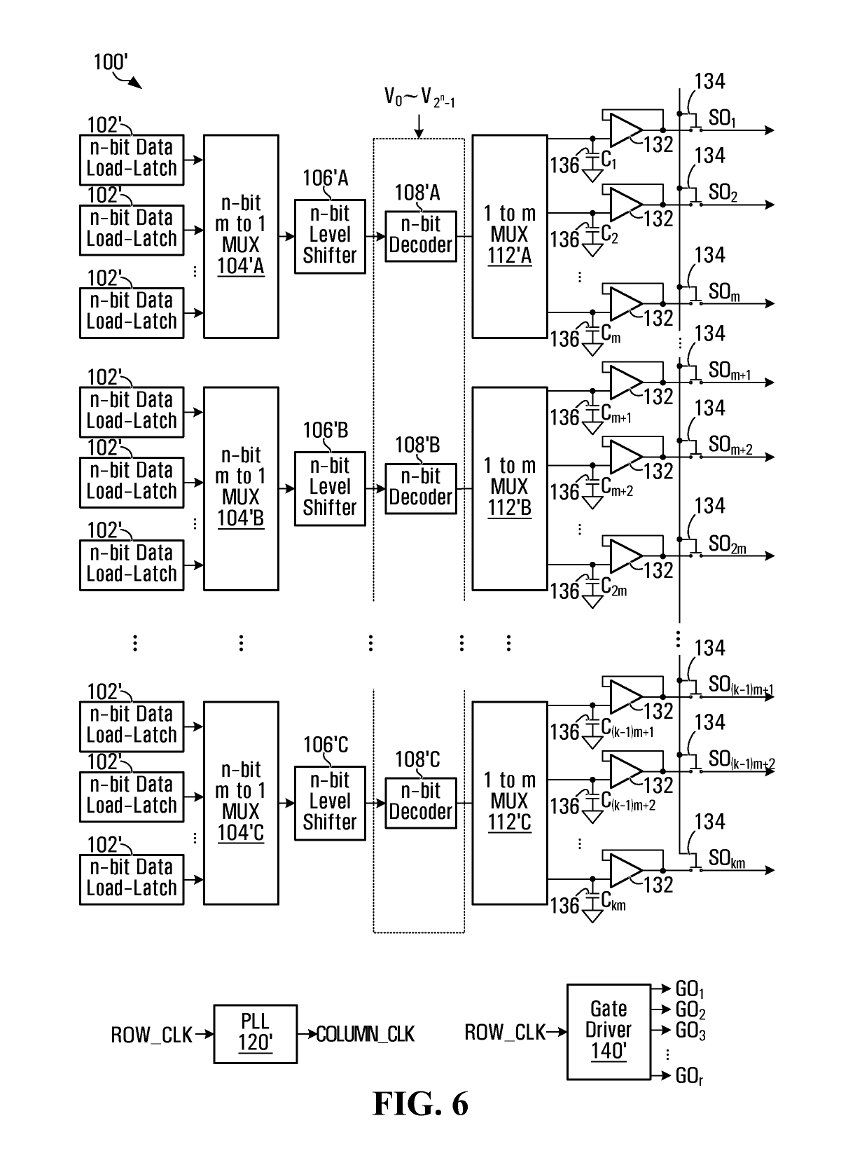

FIG. 6, schematically illustrates a further driver 100′ suitable for driving display panel 18 having q×r=(k×m)×r elements, exemplary of an embodiment of the present invention. Driver 100′ includes k×m n-bit load registers 102′, k, m:1 input selectors 104′ (only three are illustrated—input selectors 104′a, 104′b and 104′c—collectively and individually input selectors 104′), and k, 1:m analog output selectors 112′ (only three are illustrated—output selectors 112′a, 112′b and 104′c—collectively and individually input selectors 112′). The output of input selector 104′ is interconnected with the input of an output selector 112′ by way of n-bit level shifter 106′ and n-bit decoder 108′. In the depicted embodiment, selectors load registers 102′, selectors 104′, 112′ and level shifters 106′ and decoders 108′ are functionally identical to their counterparts (i.e. load registers 102, selectors 104, 112, level shifters 106, and decoders 108) in driver 100 of FIG. 4.

A single clock source 120′ similarly controls the state of selectors 104′, 112′ to ensure that the J^{th} input of a selector 104′ is converted into a corresponding analog signal at the J^{th} output of corresponding selector 112′ (e.g. the J^{th} output of selector 112′b provides an analog signal corresponding to the digital input at the J^{th} input of selector 104′b), by providing suitable clock signals at clock inputs 114′, 116′.

A gate driver 140′ identical to gate driver 140 (FIG. 4) is used to assert column lines GO.

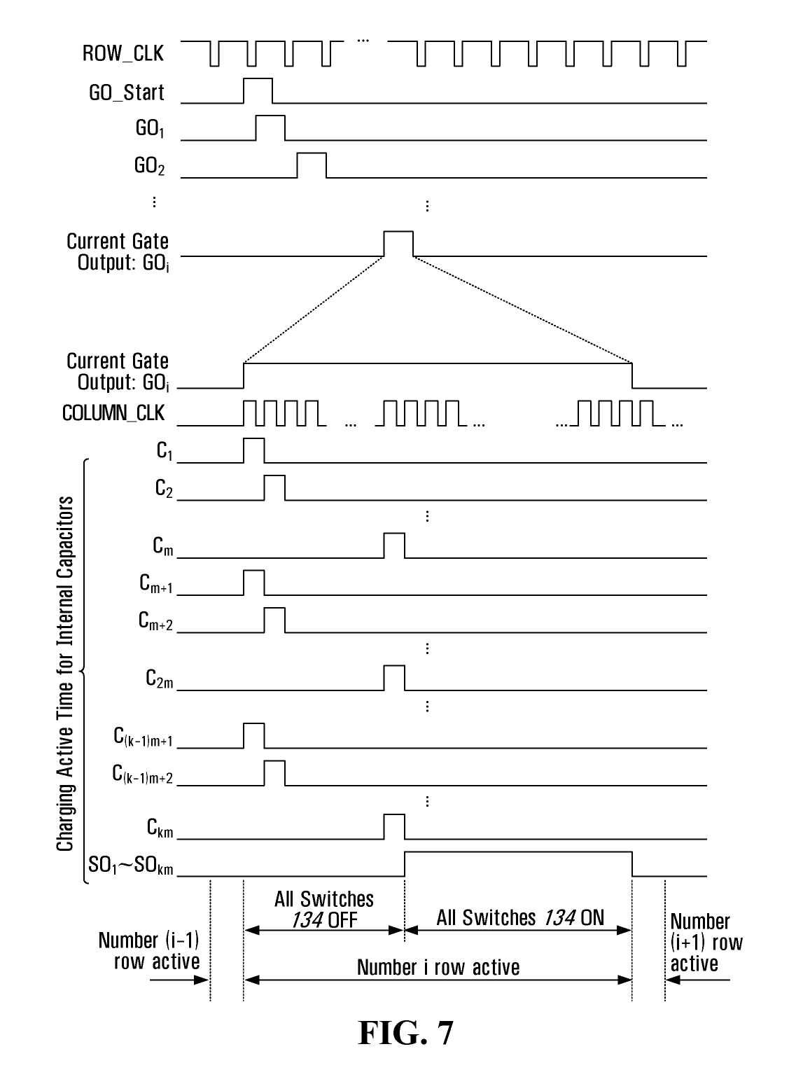

Unlike driver 100, driver 100′ includes k×m capacitors 136, k×m operational amplifiers 132, and k×m switches 134. Specifically, each output selectors 112′ sequentially present an output in each clock cycle of clock source 120′ that charge the associated capacitors 136. Conveniently, clock source 120′ (like clock source 120) is clocked at a rate that is much quicker than q/k times of the row rate. At the conclusion of m clock cycles of clock source 120′ all q=k×m capacitors 136 will thus be charged, with analog levels to be provided to an output row of display elements 12. Capacitors 136 need not be large. Signals in driver, including ROW_CLK and COLUMN_CLK, GOi and those signals Ci provided to capacitors 136, are illustrated in FIG. 7.

Switches 134 may then be activated concurrently, in parallel to drive a currently selected row of display elements 12, for the rest time of this ROW_CLK period. Since the capacitance of C of capacitors 136 could be much smaller than that of C_{LC}+C_{ST} in display element 12, the charging time can be much shorter than driver 100. The source outputs (SO) as driven charged capacitors 136 are not time-divided and may be active much longer than driver 100. In this way, driver 100′ may potentially be used with displays that requiring greater charging times for each display element 12 than those that may be driven with driver 100. Driver 100′ may thus be well suited for larger displays, such as LCD/OLED televisions, computer monitors and the like. Of course as a trade-off, driver 100′ may include a greater number of components than driver 100.

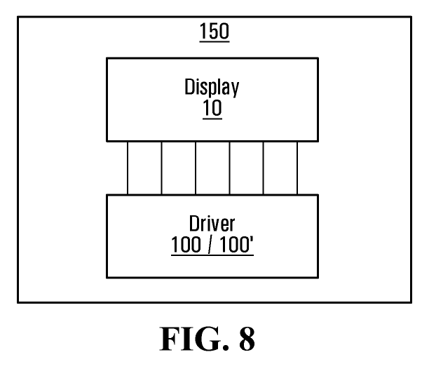

FIG. 8 illustrates a block diagram of an example device including driver 100/100′, and display 10. Other conventional components of the device, including for example, processor, user interface components, memory, etc. are not illustrated.

As will be appreciated, although the described embodiments are formed as display driver for an LCD display, the invention may similarly be embodied in a suitable LED, SED, OLED or similar driver.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A display driver circuit for driving display elements in a row of a display array, said display driver circuit comprising:
m inputs;
an input selector, having m n-bit inputs and an n-bit output for providing a selected one of said m n-bit inputs, said m n-bit inputs interconnected with said m inputs;
an n-bit digital to analog converter, receiving said n-bit output of said selector, and providing an analog output;
an output selector having an analog input interconnected with said analog output of said digital to analog converter, and m analog outputs providing said analog input at a selected one of said m analog outputs;
a clock source, to clock said input and output selectors, to sequentially provide an analog output corresponding to one of said m n-bit inputs, at a corresponding one of said m analog outputs of said output selector.

2. The circuit of claim 1, wherein said digital to analog converter comprises an n-bit decoder.

3. The circuit of claim 2, wherein said digital to analog converter comprises a buffer.

4. The circuit of claim 3, wherein said buffer comprises an operational amplifier.

5. The circuit of claim 2, further comprising a row selector to enable a row of display elements within said array of display elements.

6. The circuit of claim 1, further comprising
a further m inputs;
a second input selector, having m n-bit inputs and an n-bit output for providing a selected one of said m n-bit inputs, said m n-bit inputs interconnected with said further m inputs;
a second n-bit digital to analog converter, receiving said n-bit output of said second input selector, and providing a second analog output;
a second output selector having an analog input interconnected with said second analog output of said second digital to analog converter, and m analog outputs providing a signal at its input at a selected one of its m outputs;
wherein said clock source clocks said second input and second output selectors, to sequentially provide an analog output corresponding to one of said further m n-bit inputs, at a corresponding one of said m analog outputs of said second output selector.

7. The circuit of claim 6, further comprising a buffer interconnected to each of said m outputs.

8. The circuit of claim 6, further comprising a storage capacitor interconnected to each of said m analog outputs of said output selector.

9. The circuit of claim 8, further comprising a switch interconnected to each of said storage capacitors, to control when voltages stored in said storage capacitors are provided to said display array.

10. A method of driving an analog display array, said method comprising
receiving m digital values, representing m pixels to be displayed on said display array;
multiplexing said m digital values;
sequentially converting said m digital values to corresponding analog signals, using a single digital to analog converter, to provide m sequential analog values;
demultiplexing said m sequential analog values to create m analog signals to drive m elements in a row of said analog display array.

11. The method of claim 10, further comprising sequentially providing said m analog signals to said analog display array.

12. The method of claim 10, further comprising concurrently providing said m analog signals to said analog display array.

13. The method of claim 11, further comprising buffering each of said m analog signals.

14. The method of claim 10, further comprising providing a clock signal to synchronously perform said multiplexing and demultiplexing.

15. The method of claim 14, further comprising repeating said receiving, multiplexing, and converting, demultiplexing at a rate at which rows of said array are to be updated.

16. The method of claim 15, wherein said clock signal is generated at a rate that is at least m times as great as said rate at which rows of said array are to be updated.

17. The method of claim 12, further comprising charging capacitors with said m analog signals, prior to said concurrently providing.

18. An electronic device comprising:
a display array, having display elements arranged in rows and columns;
said display driver circuit interconnected with said display array, said display driver circuit comprising:
m inputs;
an input selector, having m n-bit inputs and an n-bit output for providing a selected one of said m n-bit inputs, said m n-bit inputs interconnected with said m inputs;
an n-bit digital to analog converter, receiving said n-bit output of said selector, and providing an analog output for driving said display elements;
an output selector having an analog input interconnected with said analog output of said digital to analog converter, and m analog outputs providing said analog input at a selected one of said m outputs;
a clock source, to clock said input and output selectors, to sequentially provide an analog output corresponding to one of said m n-bit inputs, at a corresponding one of said m analog outputs of said output selector.

19. The device of claim 18, wherein said display array comprises a two dimensional array of field effect transistors (FETs), with sources of said FETs in each column of said array interconnected to a source line, and gates of said FETs in each row of said array connected to a gate line, wherein each of said m analog outputs of said output selector is in communication with one of said source lines of said display array.

20. The device of claim 19, further comprising a gate driver sequentially driving said gate lines at a row refresh rate.

21. The device of claim 20, wherein said clock source is clocked at a rate at least m times as great as said row refresh rate.

22. The device of claim 21, wherein each of said display elements has sufficient capacitance to maintain a state of said display element until all rows of said array have been refreshed at said row refresh rate.

23. The device of claim 18, wherein each of said display elements comprises one of an LCD, OLED, or an SED display element.

24. A display driver circuit for driving display elements in a row of a display array, said display driver circuit comprising:
an m input, n-bit input multiplexer;
a digital to analog converter, receiving an n-bit output from said n-bit multiplexer;
a one input, m output, analog output multiplexer;
a clock source, to clock said input and output multiplexers, to sequentially provide an analog output corresponding to one of said m n-bit inputs, at a corresponding one of said m outputs of said output multiplexer.

25. The circuit of claim 24, wherein said digital to analog converter comprises an n-bit decoder.

26. The circuit of claim 25, wherein said digital to analog converter comprises a buffer.

27. The circuit of claim 25, further comprising a row selector to enable a row of display elements within said array of display elements.

28. The circuit of claim 25, further comprising a buffer interconnected to each of said m outputs.

29. The circuit of claim 28, further comprising a storage capacitor interconnected to each of said m analog outputs of said output selector.

30. The circuit of claim 29, further comprising a switch interconnected to each of said storage capacitors, to control when voltages stored in said storage capacitors are provided to said display array.
